(19) United States
(12) Patent Application Publication
(10) Pub. No.: US 2007/0141502 A1
(43) Pub. Date: Jun. 21, 2007

(54) Ferrite carrier core material for electrophotography, ferrite carrier for electrophotography and methods for producing them, and electrophotographic developer using the ferrite carrier

(75) Inventors: Koji Aga, Kashiwa-shi (JP); Takeshi Naito, Kashiwa-shi (JP); Tetsuya Igarashi, Kashiwa-shi (JP); Toshio Honjo, Kashiwa-shi (JP)

Correspondence Address: ROTHWELL, FIGG, ERNST & MANBECK, P.C., 1425 K STREET, N.W., SUITE 800, WASHINGTON, DC, 20005, US

(73) Assignee: POWDERTECH CO., LTD., Kashiwa-shi (JP)

(21) Appl. No.: 11/446,594

(22) Filed: Jun. 5, 2006

(30) Foreign Application Priority Data
Jun. 3, 2005 (JP) JP2005-164155

(51) Int. Cl. G03G 9/113

(52) U.S. Cl. 430/111.32; 430/111.3; 430/111.41; 430/137.1; 430/137.13

(57) ABSTRACT

A ferrite carrier core material for electrophotography having a homogeneous composition, a certain surface property, a favorable fluidity, a high magnetization and a low resistance, and a ferrite carrier for electrophotography methods for producing them, and an electrophotographic developer using the ferrite carrier-core material, which exhibits a fast charge rising and a stable charge quantity with time, are provided. A ferrite carrier core material for electrophotography whose surface is divided by grooves or streaks into 2 to 50 regions per 10 μm and which has a manganese ferrite as a main component, and a method for producing the ferrite carrier core material for electrophotography using an Fe—Mn composite oxide as the raw material, and a method for producing a ferrite carrier for electrophotography are employed.

### BACKGROUND OF THE INVENTION

1. Field of the Invention

The present invention relates to a ferrite carrier core material for electrophotography which has a high magnetization, a low resistance, a homogeneous composition, a certain surface property, and a favorable fluidity, a ferrite carrier for electrophotography, methods for producing them, and an electrophotographic developer using the ferrite carrier.

2. Description of the Related Art

The two-component developer used in electrophotography is constituted of a toner and a carrier, and the carrier is a carrier material which is mixed and stirred with the toner in a development box, gives a desired charge to the toner, carries the charged toner to an electrostatic latent image on a photoreceptor, and forms a toner image. The carrier is, after having formed the toner image, held by a magnet and stays on a magnet roll, is returned again to the development box, again mixed and stirred with new toner particles, and repeatedly used in a certain period.

The two-component developer, different from one-component developers, is one in which the carrier is stirred with the toner particles, and does not only impart a desired charge, but has a function of transporting the toner. It has good controllability in developer design, and is widely used in the fields of full-color machines requiring high-quality images and high-speed machines requiring reliability and durability of image sustainability.

Recent years' high-quality and color imaging is remarkable, and then the need of responding to such a situation in carriers as well becomes pressing.

Although the largest effect on the high-quality imaging is to make the carrier of a small particle size, only making the carrier simply of a small particle size reduces the magnetization per carrier particle, and causes the carrier scattering. Therefore, a carrier having a high magnetization becomes necessary.

The color imaging is characterized in the highness of the printing rate of each color, and the carrier is demanded to have a capability of making a large amount of toner become charged in a shorter time to a necessary charge level, and to smoothly transfer the charge though depending on the congeniality with the toner. For that, a lower-resistance carrier is preferable.

Although, as a material for the above carrier, a magnetite or a ferrite having a composition of being very rich in iron is expected from the viewpoint of the targeted magnetization and resistance, a single magnetite has a tendency of having a large residual magnetization and coercive force, and is liable to generate various image faults. For resolving these drawbacks, manganese is preferably added in an appropriate amount.

However, by so far proposed methods for producing a ferrite carrier core material, manganese is not sufficiently dispersed, and liable to deviate.

Namely, when β-Fe₂O₃ used as a common ferrite raw material is used as the main raw material, elements added as by materials other than Fe have a high possibility of deviating, and if made to be of a small particle size, it has a problem of the carrier scattering being liable to occur.

On the other hand, regarding the shape, although it is a well-known fact that spherical ferrite particles are used as a carrier, the true sphere hardly generates friction, and does not have a sufficient charge imparting capability. Especially since the carrier for full-color image has a high printing rate, if it cannot impart a sufficient friction charge, it may possibly be directly linked with the decrease in the printing quality.

Therefore, the surface of the carrier core material particles preferably has a suitable unevenness. Especially a state that the surface is plurally divided is preferable, and the unevenness is desirably present to such a degree that the fluidity on a magnet roll is not deteriorated.

However, when the unevenness is present beyond need, a toner does not only have a possibility of being broken only by stirring a developer in actual machines, but a stress is exerted on a magnet roll driving part because of a poor fluidity of the developer, possibly causing the driving part to be damaged in the worst case. In a case of a resin-coated carrier, the exfoliation of the coating resin sometimes brings about a large variation in electric properties such as charging properties and resistance in actual machines.

Especially regarding the surface property, the unevenness of the carrier core material surface of such a degree that the presence can be confirmed by a SEM photograph is conventionally believed to generate due to gases such as moisture and carbon dioxide escaping at the sintering time, and pores are believed to be present not only on the carrier core material surface but also reach the interior. As a result, in comparison with a carrier core material whose surface does not at all have or slightly has the unevenness, the apparent density does not only becomes low, but the fluidity becomes much worsened, and the charging properties in actual machines are inferior. Besides, the use as a carrier does not allow a prolonged life because of the brittleness. A carrier core material whose surface has the unevenness and the carrier core material according to the present invention described later are clearly different.

Japanese Patent Laid-Open No. 06-483967 and Japanese Patent Laid-Open No. 2000-89518 describe carriers composed of a magnetite and a lithium ferrite for which the grain size (sintered primary particle) is defined, and the objects are to prevent the exfoliation of the resin-coated layer and to sharply maintain the charge distribution of the toner under high temperature and high humidity conditions, but they cannot be said to be sufficient from the viewpoint of the objects to achieve the improvement in the developer fluidity in actual machines and the charging stability of the carrier with time.

Conventional small particle size carrier core materials have a large problem also with the classifying precision on production, and are known to rapidly worsen in yield with the smaller particle size. Besides, due to large raw material particles, they have a problem that elements hardly melt and diffuse and easily deviate. Moreover, the variation in the surface property possibly due to the element deviation is remarkably developed, adversely affecting not only characteristics of the carrier core materials such as the fluidity, density and apparent density, but the process yield including classification precision.

In a case of a manganese ferrite, if the sintering is not performed at 1,160° C. or higher, a high magnetization cannot be maintained. However, with the increased sintering temperature, the generation of the unevenness on the carrier core material surface becomes difficult. With the temperature lower than that, a carrier core material whose magnetization is high, whose resistance is low, and whose surface has unevenness cannot be fabricated because of too much reduced magnetization. Japanese Patent No. 3463840 describes that α-Fe₂O₃ is ground into about 1 μm, thereafter heated and reduced, and the obtained iron oxide is mixed with water to prepare a slurry, which is sprayed and granulated by a spray drier, and sintered and classified. However, it does not use a submicron raw material. Therefore, a carrier core material having the surface property described later in the present invention is difficult to obtain.

In Japanese Patent No. 2935219, an attempt in a manganese-zinc ferrite is performed to make the composition homogeneous by using as raw materials α-Fe₂O₃and various kinds of manganese compounds, and further iron titanate and/or manganese titanate. However, it uses too large raw material particles, and is a producing method insufficient to obtain a carrier core material having the surface property and homogeneity of elements as is described later in the present invention.

### SUMMARY OF THE INVENTION

Accordingly, an object of the present invention provides a ferrite carrier core material for electrophotography, and a ferrite carrier for electrophotography which have a homogeneous composition, a certain surface property, a favorable fluidity, a high magnetization and a low resistance, and methods for producing them, and an electrophotographic developer, using the ferrite carrier, which has a fast charge rising and a stable charge quantity with time.

As the results of the extensive studies, the present inventors have found that a carrier core material which has as a main component a manganese ferrite having a homogeneous composition, a specific surface property, a crystallite size in a certain range and a molar ratio of Fe to Mn (Fe/Mn) in a specific range can achieve the above object, and achieved the present invention.

That is, the present invention provides a ferrite carrier core material for electrophotography having a surface divided into 2 to 50 regions per 10 μm square by grooves or streaks, the ferrite carrier core material comprising a manganese ferrite as a main component.

The ferrite carrier core material according to the present invention preferably has a crystallite size of 130 to 400 Å and a molar ratio of Fe to Mn (Fe/Mn) of desirably 4 to 16.

In the ferrite carrier core material for electrophotography, a part of Fe and Mn of the manganese ferrite composition is substituted with at least one element selected from the group consisting of Mg, Ca, Sr and Ti, and the sum of the contents thereof is preferably 4 mol % or less.

The ferrite carrier core material according to the present invention preferably has a magnetization of 60 to 95 Am²/kg in a magnetic field of 3·K-1,000/4π·A/m.

The ferrite carrier core material according to the present invention preferably has a volume resistance of 1×10² to 1×10⁶ ω·cm.

The ferrite carrier core material according to the present invention preferably has a true density of 4.5 to 5.5 g/cm³.

The ferrite carrier core material according to the present invention preferably has an average particle size of 15 to 120 μm.

The ferrite carrier for electrophotography according to the present invention is obtained by coating surface of the ferrite carrier core material with a resin, which is preferably a silicone resin or a modified silicone resin.

The above resin preferably contains a quaternary ammonium salt catalyst, an aluminum catalyst or a titanium catalyst.

The present invention provides also a method for producing a ferrite carrier core material for electrophotography, the method comprising grinding a composite oxide having as main components Fe and Mn at a molar ratio (Fe/Mn) of 4 to 16 mixing the ground particles, granulating the mixture, sintering the granules, crushing the sintered product and classifying the crushed particles, wherein the sintering is performed at an oxygen concentration of 5 vol % or less.

In the production method according to the present invention, the composite oxide is desirably particles produced by a wet synthesis.

In the production method according to the present invention, the composite oxide particles preferably have an average particle size of 1 μm or less.

The method for producing a ferrite carrier for electrophotography according to the present invention comprises coating a ferrite carrier core material obtained by the above production method with a resin.

The present invention also provides an electrophotographic developer comprising the above ferrite carrier and a toner.

The ferrite carrier core material for electrophotography according to the present invention has a homogeneous composition, a certain surface property, a favorable fluidity, a high magnetization and a low resistance. Then, the electrophotographic developer using the ferrite carrier in which the ferrite carrier core material is coated with a resin has a fast charge rising and a stable charge quantity with time. The production method according to the present invention also provides an inexpensive and stable production of the ferrite carrier for electrophotography.

### BRIEF DESCRIPTION OF THE DRAWINGS

FIG. 1 shows a SEM photograph of Example 2; and

FIG. 2 shows a SEM photograph of Comparative Example 1.

### DETAILED DESCRIPTION OF THE PREFERRED EMBODIMENTS

Hereinafter, the preferred embodiments to implement the present invention will be described.

<A ferrite Carrier Core Material for Electrophotography and a Ferrite Carrier for Electrophotography According to the Present Invention>

The surface property of the carrier core material particles according to the present invention is characterized in that although pores reaching the interior are scarcely present, the surface has much unevenness. Therefore, in spite of that the unevenness of the degree of being confirmed by a SEM photograph is present on the surface, the true density and the fluidity are suitably secured, and the carrier core material particles are suitably used as a carrier core material for electrophotography. Since the surface property of a carrier core material does not contribute directly to the carrier core material fluidity, the carrier core material does not only have a fluidity equal to that of a carrier core material having no or a little unevenness part on the carrier core material surface, but the fluidity change accompanying the particle size change is also equal to that of a carrier core material having no or a little unevenness part on the carrier core material surface. Consequently, the carrier according to the present invention allows a prolonged life while maintaining sufficient charging properties.

The ferrite carrier core material for electrophotography according to the present invention, whose surface is plurally divided by grooves or streaks, and which is one composed of a manganese ferrite in which the divided area does not depend on the carrier core material particle size, is preferably used. The number of the divided regions is 2 to 50 per 10 μm square in the SEM photograph, preferably 5 to 50, more preferably 5 to 30. The counting method of the number of the divided regions is to take a SEM photograph and measure the dividing number per 10 μm square at the vicinity of the center of the carrier core material particle.

In the ferrite carrier core material for electrophotography according to the present invention, the crystallite size is desirably 130 to 400 Å, and the molar ratio of Fe to Mn (Fe/Mn) is desirably 4 to 16. With the crystallite size of less than 130 Å, it has the same crystallinity as a ferrite carrier core material produced by using α-Fe₂O₃ and a manganese compound of several to several ten microns in particle size, and Mn atoms in the ferrite carrier core material may possibly deviate. With that exceeding 400 Å, generation of α-Fe₂O₃ more than necessary causes a low magnetization and a high resistance, thus indicating that desired carrier core material particles cannot be obtained. With the molar ratio of Fe to Mn (Fe/Mn) of less than 4, a sufficiently high magnetization may possibly not be obtained depending on the sintering condition. With that exceeding 16, since the ferrite carrier core material substantially approaches a magnetite itself, the manganese-containing effect cannot be obtained. When further out of the above ranges, no carrier core material particles exhibit the favorable surface property. The crystal structure and the crystallite size are measured by the X-ray diffractometry.

In the above manganese ferrite, a part of Fe and Mn in the composition may be substituted with at least one element selected from the group consisting of Mg, Ca, Sr and Ti, and the content is desirably 4 mol % or less. With the content of the substituent element exceeding 4 mol %, since the magnetization is too much decreased, or the resistance is too much increased, the desired characteristics for a carrier core material may possibly be difficult to obtain. By such a substitution within 4mol %, the magnetization, resistance and true density can be controlled without deteriorating the features of the present invention.

In the carrier core material according to the present invention, the magnetization of the scattered carrier core material preferably satisfies 1≧σ_{scattered material}/σmain body≧0.95 in the scattering test, and the carrier core material preferably has a manganese ferrite as a main component. A σ_{scatteredmaterial}/σ_{main body} of less than 0.95 means a high possibility of the carrier scattering in actual machines. A σ_{scattered material}/σ_{main body} becomes one, when σ_{scattered material}=σ_{main body}. This evaluation is conducted as follows. The 100 main body Am²/kg is let denote the magnetization of the carrier core material at 1K·1,000/4π·A/m. On a cylindrical sleeve having a region having a peak magnetic flux density of 100 mT in the direction perpendicular to the axis, the carrier core material is magnetically held; only the magnetic pole region having the peak magnetic flux density is opened; the cylindrical sleeve is rotated for 30 min to impart to the carrier core material a leaving force three times the gravity force in the direction perpendicular to the rotation axis; and the σ_{scattered material} Am²/kg is let denote the magnetization of the leaving carrier core material having left from the opening at 1K·1,000/4π·A/m.

In the carrier core material according to the present invention, the magnetization in a magnetic field of 3K·1,000/4π·A/m is desirably 60 to 95 Am²/kg. With the magnetization of less than 60 Am²/kg, when the carrier is made to be of a small particle size, the magnetization per carrier particle becomes small, and may cause to generate the carrier scattering. With the magnetization exceeding 95 Am²/kg, the bristles of the developer on magnetic brushes become too hard, possibly causing deterioration in image quality. The magnetization control is done by substituting a part of Fe and Mn in the ferrite composition with at least one element selected from the group consisting of Mg, Ca, Sr and Ti, adjusting the molar ratio of Fe to Mn (Fe/Mn), and controlling the sintering condition, as described above.

In the carrier core material according to the present invention, the volume resistance is desirably 1×10² to 1 ×10⁶ Ω·cm. With the volume resistance exceeding 1×10⁶ Ω·cm, the resistance becomes too high, and may cause to impede the electron transfer accompanying the friction charge. With the resistance of less than 1×10² Ω·cm, the resistance is too low, and may cause the decrease in charging.

In the carrier core material according to the present invention, the true density is desirably 4.5 to 5.5 g/cm³. With the true density of less than4.5g/cm³, even if the carrier has an element distribution difficult to scatter, the magnetization per carrier particle decreases, so the carrier scattering cannot be suppressed. The true density exceeding 5.5 g/cm³ is difficult to obtain in the composition having Fe and Mn as the main component. The control of the true density is done by substituting a part of Fe and Mn in the ferrite composition with at least one element selected from the group consisting of Mg, Ca, Sr and Ti, as described above.

In the carrier core material according to the present invention, the average particle size is desirably 15 to 120 μm, and more desirably 25 to 90 μm for aiming at a higher image quality. With the average particle size of less than 15 μm, the magnetization per carrier particle becomes low, and cannot suppress the carrier scattering. With the average particle size exceeding 120 μm, the image quality becomes too coarse, and is unsuitable for electrophotographic applications. Further, since the specific surface area becomes small, and then a sufficient charge cannot be given to a toner in full-color and high-speed machines involving the intense toner replacement and a high printing rate, it is hardly used.

The ferrite carrier for electrophotography according to the present invention is one in which the surface of the above carrier core material is coated with a resin. If the resin coating is not performed, the smooth friction charging with a toner may possibly not be achieved. Further, since a phenomenon that the toner adheres to the carrier core material surface and is not charged occurs easily, and the prolonged life of the carrier cannot be achieved, it is not preferable. The coating resin is desirably a silicone resin or a modified silicone resin. The modified silicone resin is preferably acrylic-modified, epoxide-modified, urethane-modified, etc. Besides, the use of a silane coupling agent in combination can even enhance the strength of the coating layer. The silane coupling agent is preferably a linear alkylsilane coupling agent, aminosilane coupling agent, epoxysilane coupling agent, fluorosilane coupling agent, etc.

The coating amount of a resin is preferably 0.01 to 10.0 wt. % to the carrier core material, further preferably 0.3 to 7.0 wt. %. It is most preferably 0.5 to 5.0 wt. %. With the coating amount of less than 0.01 wt. %, a uniform coating layer is hardly formed on the carrier core material surface. By contrast, with that exceeding 10.0 wt. %, carrier particles aggregate, causing the decrease in productivity including yield, and the variation in developer characteristics such as fluidity or charge quantity in actual machines.

A catalyst for curing or crosslinking the resin is preferably one other than organic tins because of the easy controllability of the curing or crosslinking time, and desirably contains especially a quaternary ammonium salt catalyst, aluminum catalyst or titanium catalyst. From the viewpoint of further stabilizing the charging characteristics, it desirably contains an aluminum catalyst. On the other hand, organic tin catalysts are endocrine disrupting chemicals, and may adversely affect workers engaging in coating work.

<Methods for Producing a Ferrite Carrier Core Material for Electrophotography and a Ferrite Carrier for Electrophotography According to the Present Invention>

Next, methods for producing a ferrite carrier core material for electrophotography and a ferrite carrier for electrophotography according to the present invention will be explained.

The producing methods according to the present invention use composite oxide particles, having Fe and Mn as main component, produced by, for example, the wet synthesis. In the Fe—Mn composite oxide obtained by the wet synthesis, Fe and Mn are mixed, needless to say, in the atomic level, but since the primary particle sizes of the raw materials are small, and the volume change by sintering is large in comparison with the case where α-Fe₂O₃ and a manganese compound of several to several ten microns in particle size are used, particles before sintering can be made relatively large. Generally, particles having a larger size are more easily classified, and particles having a smaller size are more difficult to classify. Therefore, if particles have been classified in a state of a large particle size before sintering, the particle size distribution after sintering becomes relatively easily uniformalized, providing a merit of less burden in the later process. Since because the primary particle sizes of the raw materials are small, the surface energy is high, and the reactivity is superior, the sintering at a lower temperature is allowed, whereby the surface property of the carrier core material particles is easily controllable. A method for producing this composite oxide is, for example, as follows.

A ferrous salt such as ferrous sulfate and a soluble manganese salt such as manganese sulfate are dissolved in warm water (solution A).

Then, an alkali in an amount of completely neutralizing the ferrous salt and the soluble manganese salt is dissolved in water (solution B). Examples of the alkali solution include sodium hydroxide, potassium hydroxide and sodium carbonate.

Regarding an organic acid to be added, Fe²⁺ and Mn²⁺ are converted into Fe₃O₄ and MnFe₂O₄ , whose weights are calculated from the numbers of total moles of Fe²⁺ and Mn²⁺, and the organic acid of 1 wt. % to the total weight is dissolved in warm water. The organic acid is desirably one having two or more carboxy groups, and tartalic acid is preferably used.

The organic acid aqueous solution is added to the solution B, and raised to a temperature of, for example, 90° C. (solution C).

The solution A is added to the solution C held at the above temperature while being stirred (slurry D). To the slurry D containing Fe(OH)₂ and Mn(OH)₂, an alkali solution is added to adjust the pH at 9 to 11.5. The alkali solution uses sodium hydroxide, etc., as above.

Then, an oxidizing agent is added to the slurry D, and oxidized till Fe²⁺ and Fe(OH)₂ become completely absent. The oxidizing agent includes air, oxygen, a hydrogen peroxide solution and sodium nitrate, but is preferably a compressed air for the viewpoint of the suitable oxidizing rate. The oxidizing rate depends on the Fe²⁺ concentration as well in the slurry D, but is preferably about 3 to 10 g/L per hour in average.

The degree of oxidation is judged by whether or not any substance to be oxidized is left in the slurry D. That is, the judgment of whether or not Fe²⁺ and Fe(OH)₂ are absent involves sampling the slurry D, making it of sulfuric acid acidity and thereafter titrating with potassium permanganate, or observing the change in the potential of an ORP instrument.

After finishing the oxidation, the pH of the slurry D is decreased to about 6 by a pH adjusting agent to dissolve excess hydroxides other than those of Fe and Mn present in the slurry; thereafter, the slurry is separated into a solid substance and moisture after salts remained on the solid substance surface are removed by a solid-liquid separation method such as the filter press. As the pH adjusting agent, a dilute sulfuric acid or a dilute hydrochloric acid in a low concentration is usable.

The solid substance is dried in a drier to a state of no moisture, and ground in a grinder to obtain a Fe—Mn composite oxide.

The composite oxide particles have desirably an average particle size of 1 Mm or less. With the average particle size exceeding 1 Mm, since the surface energy of the raw material particles becomes low, a carrier core material having a desired surface property is unfavorably difficult to obtain. The shape of the particles is not limited as long as being particulate, but if they are of a polyhedron exceeding octahedron or hexahedron, they are excellent in dispersibility in water, and preferably allow the reduced grinding and mixing time in a stirring bath type medium stirring grinder.

In the production method according to the present invention, the composite oxide particles having Fe and Mn as main components, produced by the wet synthesis as above are crushed and mixed using a stirring bath type medium stirring grinder, etc. Instead of a stirring bath type medium stirring grinder, a high-speed stirring type dispersing apparatus which has a larger shearing force can be usable. On the grinding and mixing, carbonate salts and oxides of Mg, Ca, Sr and Ti in submicron order may be dispersed in advance in water, and then added to the main raw materials.

Then, the particles are granulated by a spray drier, and sintered in an atmosphere-controllable electric furnace at a temperature equal to or higher than 1,160° C. The sintering atmosphere is preferably a non-oxidizing atmosphere. A high oxygen concentration in sintering makes α-Fe₂O₃ easily produced in the crystal, possibly resulting in not achieving a desired resistance and magnetization. A lower oxygen concentration is better. The atmosphere control can suitably involve use of a non-oxidizing or reducing gas such as nitrogen gas, ammonia gas or hydrogen gas, but preferably involves use of nitrogen gas alone or a mixture of nitrogen gas with oxygen or the air in viewpoint of safety.

The sintering atmosphere has preferably an oxygen concentration of 5 vol % or less. With the oxygen concentration exceeding 5 vol %, the magnetization of the sintered substance becomes too low, unfavorably causing the carrier scattering. Besides, since the resistance of the ferrite carrier core material becomes high, a possibility that a desired ferrite carrier core material cannot be obtained is enhanced. From this view point, for obtaining a more highly magnetized ferrite carrier core material, the oxygen concentration is further preferably 3 vol % or less, most preferably 1 vol % or less.

Thereafter, the sintered substance is crushed by an impact grinder, and classified to obtain a ferrite carrier core material. The classifying method favorably involves use of various sieves, or the air sifting.

A method for coating a resin as described above on the above ferrite carrier core material involves coating by well-known methods, for example, the brush coating method, dry process method, spray dry system by a fluidized bed, rotary dry system and liquid-immersion and dry method by a universal stirrer. For improving the coating ratio, the method by a fluidized bed is preferable.

For baking the resin after the resin is coated on the carrier core material, either of an externally heating system and an internally heating system can be used, and, for example, a fixed-type-or flow-type electric furnace, rotary electric furnace, burner furnace, or the microwave can be used. The temperature for baking is different depending on a resin to be used, and a temperature not less than the melting point or the glass transition temperature is needed. For a thermosetting resin, a condensation-cross linkable resin or the like, the temperature needs to be raised to full curing.

<A Developer for Electrophotography According to the Present Invention>

A developer for electrophotography according to the present invention will be explained.

Toner particles constituting a developer of the present invention include pulverized toner particles produced by the grinding method, and polymerized toner particles produced by the polymerizing method. In the present invention, toner particles obtained by either of them can be used.

The pulverized toner particles can be obtained, for example, by fully mixing a binding resin, a charge controlling agent and a colorant by a mixer such as a Henshel mixer, then melting and kneading by a twin-screw extruder, etc., cooling, grinding, classifying, adding with additives, and thereafter mixing by a mixer, etc.

The binding resin constituting the pulverized toner particles is not especially limited, but includes a polystyrene, chloropolystyrene, styrene-chlorostyrene copolymer, styrene-acrylate copolymer, styrene-methacrylate copolymer, and further, a rosin-modified maleic acid resin, epoxide resin, polyester resin and polyurethane resin. These are used alone or by mixing.

As the charge controlling agent, an optional one can be used. A positively chargeable toner includes, for example, a nigrosin dye and a quaternary ammonium salt, and a negatively chargeable toner includes, for example, a metal-containing monoazo dye.

As the colorant (coloring material), conventionally known dyes and pigments are usable. For example, carbon black, phthalocyanine blue, permanent red, chrome yellow, phthalocyanine green and the like can be used. Otherwise, additives such as a silica powder and titania for improving the fluidity and cohesion resistance of the toner can be added corresponding to the toner particle.

The polymerized toner particles are produced by a conventionally known method such as the suspension polymerization method, emulsion polymerization method, emulsion coagulation method, ester extension polymerization method and phase transition emulsion method. Such toner particles are obtained by the polymerization methods, for example, by mixing and stirring a colored dispersion liquid in which a colorant is dispersed in water using a surfactant, a polymerizable monomer, a surfactant and a polymerization initiator in an aqueous medium, emulsifying and dispersing the polymerizable monomer in the aqueous medium, and polymerizing while stirring and mixing. Thereafter, the polymerized dispersion is added with a salting-out agent, and the polymerized particles are salted out. The particles obtained by the salting-out are filtered, washed and dried to obtain the polymerized toner particles. Thereafter, the dried toner particles are optionally added with an additive.

Further, on producing the polymerized toner particle, a fixability improving agent and a charge controlling agent can be blended other than the polymerizable monomer, surfactant, polymerization initiator and colorant, thus allowing to control and improve various properties of the polymerized toner particles obtained using these. Besides, for improving the dispersibility of the polymerizable monomer in the aqueous medium, and adjusting the molecular weight of the obtained polymer, a chain-transfer agent can be used.

The polymerizable monomer used for the production of the above polymerized toner particles is not especially limited, but includes, for example, styrene and its derivatives, ethylenic unsaturated monoolefins such as ethylene and propylene, halogenated vinyls such as vinyl chloride, vinylesters such as vinyl acetate, and α-methylene aliphatic monocarboxylate such as methyl acrylate, ethyl acrylate, methyl methacrylate, ethyl methacrylate, 2-ethylhexyl methacrylate, dimethylamino acrylate and diethylamino methacrylate.

As the colorant (coloring material) used for preparing the above polymerized toner particle, conventionally known dyes and pigments are usable. For example, carbon black, phthalocyanine blue, permanent red, chrome yellow and phthalocyanine green can be used. The surface of colorants may be improved by using a silane coupling agent, a titanium coupling agent and the like.

As the surfactant used for the production of the above polymerized toner particle, an anionic surfactant, a cationic surfactant, anamphoteric surfactantandanonionic surfactant can be used.

Here, the anionic surfactants include sodium oleate, a fatty acid salt such as castor oil, an alkylsulfate such as sodium laurylsulfate and ammonium laurylsulfate, an alkylbenzenesulfonate such as sodiumdo decylbenzene sulfonate, an alkylnaphthalenesulfonate, an alkylphosphate, a naphthalenesulfonic acid-formalin condensate, a polyoxyethylene alkyl sulfate, etc. The nonionic surfactants include a polyoxyethylene alkyl ether, a polyoxyethylene aliphatic acid ester, a sorbitan aliphatic acid ester, a polyoxyethylenealkyl amine, glycerin, analiphaticacidester, an oxyethylene-oxypropylene block polymer, etc. Further, the cationic surfactants include alkylamine salts such as laurylamine acetate, and quaternary ammonium salts such as lauryltrimethylammonium chloride, stearyltrimethylammonium chloride, etc. Then, the amphoteric surfactants include an aminocarbonate, an alkylamino acid, etc.

The surfactant as above is generally used in an amount within the range of 0.01 to 10 wt. % to a polymerizable monomer. Since the use amount of such a surfactant affects the dispersion stability of the monomer, and affects the environmental dependability of the obtained polymerized toner particle, it is preferably used in the amount within the above range where the dispersion stability of the monomer is secured, and the polymerized toner particles are not excessively affected in the environmental dependability.

For the production of the polymerized toner particle, a polymerization initiator is generally used. The polymerization initiators come in a water-soluble polymerization initiator and an oil-soluble polymerization initiator, and both of them can be used in the present invention. The water-soluble polymerization initiator used in the present invention includes, for example, a peroxosulfate salt such as potassium peroxosulfate, and ammonium peroxosulfate, and a water-soluble peroxide compound. The oil-soluble polymerization initiator includes, for example, an azo compound such as azobisisobutyronitrile, and an oil-soluble peroxide compound.

In the case where a chain-transfer agent is used in the present invention, the chain-transfer agent includes, for example, mercaptans such as octylmercaptan, dodecylmercaptan and tert-dodecylmercaptan, carbon tetrabromide, etc.

Further, in the case where polymerized toner particles used in the present invention contain a fixation improving agent, as the fixation improving agent, a natural wax such as a carnauba wax, and an olefinic wax such as a polypropylene and a polyethylene and the like can be used.

In the case where polymerized toner particles used in the present invention contain a charge controlling agent, the charge controlling agent to be used is not especially limited, and a nigrosine dye, a quaternary ammonium salt, an organic metal complex, a metal-containing monoazo dye and the like can be used.

The additive used for improving the fluidity etc. of polymerized toner particles includes silica, titanium oxide, bariumtitanate, fluorine resin microparticles, acrylicrexin microparticles, etc., and these can be used alone or in combination thereof.

Further, the salting-out agent used for separating polymerized particles from an aqueous medium includes metal salts such as magnesium sulfate, aluminum sulfate, barium chloride, magnesium chloride, calcium chloride and sodium chloride.

The average particle size of the toner particles produced as above is in the range of 2 to 15 μm, preferably in the range of 3 to 10 μm. The polymerized toner particles have the higher uniformity than the pulverized toner particles. The toner particles of less than 2 μm have decreased the charging capability and are apt to bring about the fogging of image and toner scattering. That exceeding 15 μm causes the degradation of image quality.

By mixing the carrier and the toner produced as above, an electrophotographic developer is obtained. The mixing ratio of the carrier to the toner, namely, the toner concentration, is preferably set to be 3 to 15%. With less than 3%, a desired image density is hard to obtain. With more than 15%, the toner scattering and fogging of image are apt to occur.

The developer mixed as above can be used in copying machines, printers, FAXs, printing presses and the like, in the digital system, which use the development system in which electrostatic latent images formed on a latent image holder having an organic photoconductor layer are reversal-developed by magnetic brushes of the two-component developer having the toner and the carrier while impressing a bias electric field. It is also applicable to full-color machines and the like which use an alternating electric field, which is a method to superimpose an AC bias on a DC bias, when the developing bias is applied from magnetic brushes to the electrostatic latent image side.

Hereinafter, the present invention will be specifically explained by way of examples.

### EXAMPLE 1

(Production of an Fe—Mn Composite Oxide)

FeSO₄ and MnSO₄ were dissolved in warm water of 60° C. in a molar ratio of Fe²⁺:Mn²⁺=8:1 (solution A).

NaOH of an amount to completely neutralize the FeSO₄ and MnSO₄ was dissolved in water (solution B).

Fe²⁺ and Mn were converted into Fe₃O₄ and MnFe₂O₄ , whose weights were calculated from the numbers of total moles of Fe²⁺ and Mn present in the solution A, and tartalic acid of 1 wt. % to the total weight was dissolved in warm water, then added to the solution B, and raised to a temperature of 90° C. (solution C).

With the temperature kept at 90° C., the solution A was added to the solution C under stirring (slurry D). The pH of the slurry D containing Fe(OH)₂ and Mn(OH)₂ was made to be 10.5 by addition of NaOH, and the slurry D was oxidized by dispersing the compressed air in the slurry till Fe²⁺ and Fe(OH)₂ became absent. The confirmation of weather or not Fe²⁺ and Fe(OH)₂ became absent was judged by the titration of potassium permanganate after the slurry D was sampled and made to be of sulfuric acid acidity.

After finishing the oxidation, the pH of the slurry D was decreased to 6 by using a pH adjusting agent (dilute sulfuric acid) to dissolve excess hydroxides in the slurry; thereafter, salts remained on the solid substance surface were removed by a solid-liquid separation method such as the filter press. Further, the solid substance and moisture were separated; and the solid substance was dried in a drier to a state of no moisture, and ground in a grinder to obtain an Fe—Mn composite oxide. The Fe—Mn composite oxide had a polygonal shape, an average particle size of 0.2 μm, and a molar ratio of Fe to Mn (Fe/Mn) of about Fe:Mn=8:1.

(Production of a Ferrite Carrier Core Material)

The above Fe—Mn composite oxide was added with water such that the solid content was 45wt. %, ground and mixed by a stirring bath type medium stirring grinder, and then granulated by a spray drier to obtain particles before sintering (average particle size of 36 μm). The particles were sintered in an atmosphere controllable electric furnace (sintering temperature of 1,250° C., oxygen concentration of 0 vol %) to obtain a sintered substance having a manganese ferrite as a main component. By observation of the crystal structure by the X-ray diffractometry, strong peaks of Fe₃O₄ and MnFe₂O₄ were observed, and a manganese ferrite was confirmed to be the main component.

The sintered substance was crushed by an impact grinder, and classified to obtain spherical manganese ferrite core material particles of an average particle size of 35 μm. The classification was performed such that the content of particles of less than 16 μm was 5% or less.

### EXAMPLE 2

Carrier core material particles were obtained as in Example 1, but with spherical manganese ferrite carrier core particles having an average particle size of 20 μm obtained by crushing and classifying the same sintered substance as that obtained in Example 1.

### EXAMPLE 3

Particles before sintering were made by a spray drier to be of an average particle size of 103 μm, and sintered in an atmosphere controllable electric furnace (sintering temperature of 1,250° C., oxygen concentration of 0 vol %) to obtain a manganese ferrite sintered substance. The sintered substance was crushed and classified to obtain spherical manganese ferrite carrier core material particles having an average particle size of 80 μm.

### EXAMPLE 4

Carrier core material particles were obtained as in Example 1, but with a sintering temperature of 1,170° C. By observation of the crystal structure of the obtained carrier core material particles by the X-ray diffractometry, a weak peak of Fe₂O₃ in addition to strong peaks of Fe₃O₄ and MnFe₂O₄ was observed, and a manganese ferrite was confirmed to be the main component as in Example 1.

### EXAMPLE 5

Carrier core material particles were obtained as in Example 1, but using a Fe—Mn composite oxide obtained by the wet synthesis having a molar ratio of Fe to Mn (Fe/Mn) of Fe:Mn=4:1.

### EXAMPLE 6

Carrier core material particles were obtained as in Example 1, but using a Fe—Mn composite oxide obtained by the wet synthesis having a molar ratio of Fe to Mn (Fe/Mn) of Fe:Mn=16:1.

### EXAMPLE 7

MgCO₃ (average particle size of 0.8 μm) was added with water such that the solid content was 45 wt. %, and dispersed by using a dispersing apparatus (ULTRA-TURRAX T-50, manufactured by IKA-Werke GmbH). Carrier core material particles were obtained as in Example 1, but adding the MgCO₃ dispersed solution such that the molar ratio of Fe to Mn and Mg was 8:1:0.25.

### EXAMPLE 8

Carrier core material particles were obtained as in Example 7, but adding a CaCO₃ dispersed solution instead of MgCO₃.

### EXAMPLE 9

Carrier core material particles were obtained as in Example 7, but adding a SrCO₃ dispersed solution instead of MgCO₃.

### EXAMPLE 10

TiO₂ (average particle size of 0.2 μm) was added with water such that the solid content was 45 wt. %, and dispersed by using a dispersing apparatus (ULTRA-TURRAX T-50, manufactured by IKA-Werke GmbH). Carrier core material particles were obtained as in Example 1, but adding the TiO₂ dispersed solution such that the molar ratio of Fe to Mn and Ti was 8:1:0.25.

### EXAMPLE 11

### COMPARATIVE EXAMPLE 1

Carrier core material particles were obtained as in Example 1, but using particles obtained by using α-Fe₂O₃ (average particle size of 5 βm) and MnCO₃ (average particle size of 5 βm) as raw materials, adding water such that the solid content was 45 wt. %, grinding and mixing in a stirring bath type medium stirring grinder, and then granulating by a spray drier.

### COMPARATIVE EXAMPLE 2

Carrier core material particles were obtained as in Example 1, but using particles obtained by using magnetite particles produced by a wet synthesis (average particle size of 0.2 μm, octagonal shape) as a raw material, adding water such that the solid content was 45 wt. %, grinding and mixing in a stirring bath type medium stirring grinder, and then granulating by a spray drier.

### COMPARATIVE EXAMPLE 3

Carrier core material particles were obtained as in Example 1, but with the sintering atmosphere of the air.

### EXAMPLES 11 to 20

### COMPARATIVE EXAMPLES 4 TO 6

A mixture of a silicone resin KR-350, manufactured by Shin-Etsu Chemical Co., Ltd., of 150 g in terms of solid content, an aluminum catalyst (CAT-AC, manufactured by Dow Corning Toray Co., Ltd.) of 2.5 g in terms of solid content, toluene of 150 g and MEK of 150 g was prepared.

The prepared solution was coated on each carrier core material of 10 kg obtained in Examples 1 to 10 and Comparative Examples 1 to 3 in a universal mixer held at 50° C. After confirming that toluene and MEK were completely volatilized at room temperature, the each resultant was cured in a hot air drier at 250° C. for 2 h.

After curing, each resultant was crushed, classified, and electromagnetically separated to obtain corresponding resin-coated carrier particles.

### EXAMPLE 21

Resin-coated carrier particles were obtained as in Example 11, but using an acryl-modified silicone resin KR-9706, manufactured by Shin-Etsu Chemical Co., Ltd., as the coating resin.

### EXAMPLE 22

Resin-coated carrier particles were obtained as in Example 11, but using a titanium catalyst (Orgatix TC-100, manufactured by Matsumoto Chemical Ind., Co., Ltd.) as the catalyst.

### EXAMPLE 23

Resin-coated carrier particles were obtained as in Example 11, but using a quaternary ammonium salt catalyst (CR-13, manufactured by GE Toshiba Silicones Co., Ltd.) as the catalyst.

[Evaluation Tests]

1. Evaluation of Ferrite Carrier Core Materials

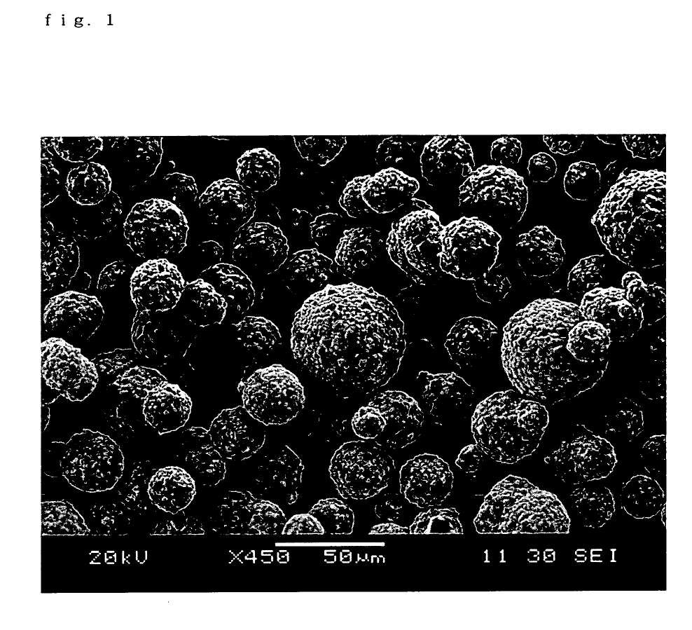

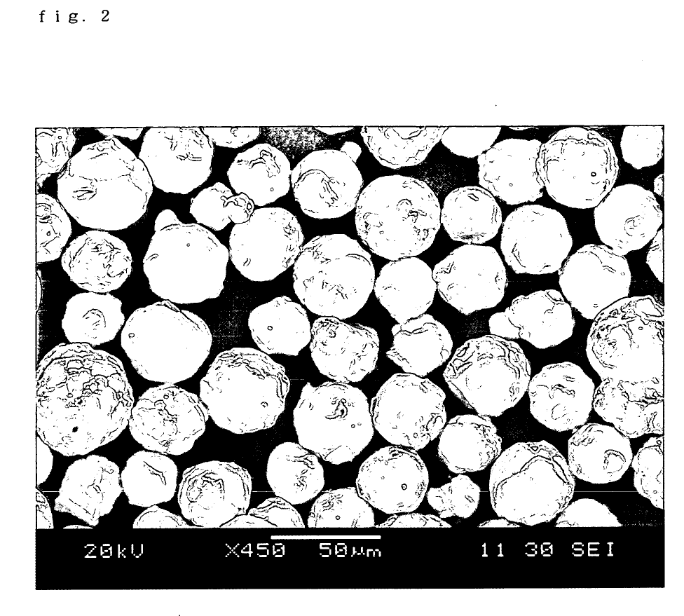

The ferrite carrier core materials of Examples 1 to 10 and Comparative Examples 1 to 3 were evaluated for their characteristics. The results are shown in Table 1. The characteristics evaluation involve the average particle size, surface property (number of regions per 10 μm square), X-ray diffractometry, homogeneity of elements (crystallite size), powder properties (true density, fluidity and apparent density), magnetic properties (magnetization, residual magnetization, coercive force and scattered material magnetization) and electric property (volume resistance). The results are shown in Table 1. SEM photographs of Example 2 and Comparative Example 1 are shown in FIG. 1 and FIG. 2.

<Evaluation of Properties>

The property evaluations were conducted by the following methods.

(Average Particle Size)

The average particle size was measured using a Microtrac Particle Size Analyzer (trade name; Model: 9320-X100) manufactured by Nikkiso Co., Ltd.

(Surface Property)

The divided region number per 10 μm square in the vicinity of the center of each of 30 carrier core material particles was measured by taking SEM photographs, and a divided region number was let denote an averaged value (discarded after the decimal point) by-the measuring particle number.

(Crystallite Size)

The crystallite size was measured by X-ray diffractometry, and calculated using the strongest peak of a spinel emerging at about 65° to 80°.

(True Density)

The true density was measured using a pycnometer according to JIS R9301-2-1.

(Fluidity)

The fluidity was measured according to JIS-Z2502 (Metallic powders-Determination of fluidity by means of a calibrated funnel).

(Apparent Density)

The apparent density was measured according to JIS-Z2504 (Metallic powders-Determination of apparent density-Funnel method).

(Magnetic Properties)

The magnetic properties were measured using an integral-type B-H tracer BHU-60 (manufactured by Riken Denshi Co., Ltd.). An H coil for measuring magnetic field and a 4πI coil for measuring magnetization were put in between electromagnets. In this case, a sample is put in the 4πI coil. Outputs of the H coil and the 4πI coil when the magnetic field H was changed by changing the current of the electromagnets are each integrated; and with the H output as the X-axis and the 4πI coil output as the Y-axis, a hysteresis loop is drawn on a chart. The measurement was conducted under the conditions of the sample filling amount: about 1 g, the sample filling cell: inner diameter of 7 mmφ±0 .02 mm, height of 10 mm±0. 1 mm, and 4πI coil: winding number of 30. Here, the magnetizations of the main body and the scattered material were measured by the above method.

(Volume Resistance)

A sample was filled to a height of 4 mm in a fluororesin cylinder of 4 cm² in cross-section; electrodes were attached to both ends thereof; further a weight of 1 kg was put thereon; and the resistance was measured. The resistance was measured at an applied voltage of 100V by an insulation resistance tester 6517A manufactured by Keithley Instruments Inc., to calculate the volume resistance.

2. Evaluation of Resin-Coated Ferrite Carriers

The properties of the resin-coated ferrite carriers of Examples 11 to 23and Comparative Examples 4 to 6 were evaluated. The results are shown in Table 2. The property evaluations were conducted for the electric property (volume resistance) and the charging property by stirring time.

<Property Evaluations>

The property evaluations were measured by the following methods.

(Volume Resistance)

The volume resistance was measured by the method as described above.

(Charge Quantity)

A carrier of 23 g and a toner of 2 g (toner concentration of 8%) were charged in a glass bottle of 100 cc, stirred by a ball mill, and sampled at every stirring time to measure the charge quantity. The stirring by the ball mill was set such that the glass bottle rotated at 100 rpm. The charge quantity was measured by a q/m-meter manufactured by Epping GmbH.

| | Raw material Condition | | | | | | | |
|---|---|---|---|---|---|---|---|---|
| | | | | | Other added | | Sintering Condition | |
| | | Raw material | | | element | | Sintering | |
| | Kind of raw | particle | Fe | Mn | | Amount | temperature | Sintering |
| No. | material | size (μm) | (mol) | (mol) | Kind | (mol) | (° C.) | atmosphere |
| Example 1 | Wet synthesis | 0.2 | 8 | 1 | — | — | 1250 | N₂ |
| | (Fe—Mn | | | | | | | |
| | compound | | | | | | | |
| | oxide) | | | | | | | |
| Example 2 | Wet synthesis | 0.2 | 8 | 1 | — | — | 1250 | N₂ |
| | (Fe—Mn | | | | | | | |
| | compound | | | | | | | |
| | oxide) | | | | | | | |
| Example 3 | Wet synthesis | 0.2 | 8 | 1 | — | — | 1250 | N₂ |
| | (Fe—Mn | | | | | | | |
| | compound | | | | | | | |
| | oxide) | | | | | | | |
| Example 4 | Wet synthesis | 0.2 | 8 | 1 | — | — | 1170 | N₂ |
| | (Fe—Mn | | | | | | | |
| | compound | | | | | | | |
| | oxide) | | | | | | | |
| Example 5 | Wet synthesis | 0.2 | 4 | 1 | — | — | 1250 | N₂ |
| | (Fe—Mn | | | | | | | |
| | compound | | | | | | | |
| | oxide) | | | | | | | |
| Example 6 | Wet synthesis | 0.2 | 16 | 1 | — | — | 1250 | N₂ |
| | (Fe—Mn | | | | | | | |
| | compound | | | | | | | |
| | oxide) | | | | | | | |
| Example 7 | Wet synthesis | 0.2 | 8 | 1 | Mg(MgCo₂, | 0.25 | 1250 | N₂ |
| | (Fe—Mn | | | | 0.8 μm) | | | |
| | compound | | | | | | | |
| | oxide) | | | | | | | |
| Example 8 | Wet synthesis | 0.2 | 8 | 1 | Ca(CaCo₂, | 0.25 | 1250 | N₂ |
| | (Fe—Mn | | | | 0.8 μm) | | | |
| | compound | | | | | | | |
| | oxide) | | | | | | | |
| Example 9 | Wet synthesis | 0.2 | 8 | 1 | Sr(SrCo₂, | 0.25 | 1250 | N₂ |
| | (Fe—Mn | | | | 0.8 μm) | | | |
| | compound | | | | | | | |
| | oxide) | | | | | | | |
| Example 10 | Wet synthesis | 0.2 | 8 | 1 | Ti(TiO₂, | 0.25 | 1250 | N₂ |
| | (Fe—Mn | | | | 0.2 μm) | | | |
| | compound | | | | | | | |
| | oxide) | | | | | | | |
| Comparative | α-Fe₂O₃, MnCO₃) | 5 | 8 | 1 | — | — | 1250 | N₂ |
| Example 1 | | | | | | | | |
| Comparative | Wet synthesis | 0.2 | 8 | 0 | — | — | 1250 | N₂ |
| Example 2 | octogonal | | | | | | | |
| | magnetide) | | | | | | | |
| Comparative | Wet synthesis | 0.2 | 8 | 1 | — | — | 1250 | Air |
| Example 3 | (Fe—Mn | | | | | | | |
| | compound | | | | | | | |
| | oxide) | | | | | | | |

| | Characteristic value of carrier core material | | | | | | | | |
|---|---|---|---|---|---|---|---|---|---|
| | | Surface | | | | | | | |
| | | property | | | | | | | |
| | Average | Number of | | | | Homogeniety | Powder property | | |
| | particle | divided | X-ray diffractometry | | | of element | True | Fluidity | Apparent |
| | size | regions | Fe₃O₄ | MnFe₃O₄ | Fe₃O₃ | Crystallite | density | (sec/ | density |
| No. | D50 (um) | (average) | peak | peak | peak | size (Å) | (g/cm²) | 50 cc) | (g/cm²) |
| Example 1 | 35 | 10 | present | present | absent | 174.8 | 5.0 | 41.8 | 2.24 |
| Example 2 | 20 | 10 | present | present | absent | 174.8 | 5.0 | 58.5 | 2.09 |
| Example 3 | 100 | 14 | present | present | absent | 176.4 | 5.0 | 21.9 | 2.64 |
| Example 4 | 35 | 24 | present | present | slightly | 375.2 | 5.0 | 48.9 | 2.12 |
| | | | | | present | | | | |
| Example 5 | 35 | 12 | present | present | absent | 158.1 | 5.0 | 44.9 | 2.26 |
| Example 6 | 35 | 6 | present | present | absent | 180.5 | 5.0 | 47.8 | 2.25 |
| Example 7 | 35 | 9 | present | present | absent | 131.4 | 4.8 | 44.8 | 1.98 |
| Example 8 | 35 | 3 | present | present | absent | 140.1 | 4.8 | 45.0 | 2.01 |
| Example 9 | 35 | 8 | present | present | absent | 135.4 | 5.0 | 47.2 | 2.11 |
| Example 10 | 35 | 5 | present | present | absent | 151.2 | 4.9 | 47.4 | 2.15 |
| Comparative | 20 | 1 | present | present | absent | 101.6 | 5.1 | not flow | 2.19 |
| Example 1 | | | | | | | | | |
| Comparative | 20 | 1 | present | Abcent | present | 171.6 | 5.2 | not flow | 2.28 |
| Example 2 | | | | | | | | | |
| Comparative | 20 | 10 | Absent | slightly | present | 415.6 | 5.0 | not flow | 2.16 |
| Example 3 | | | | present | | | | | |

| | Characteristic value of carrier core material | | | | | |
|---|---|---|---|---|---|---|
| | Magnetic property (3K · 1000/4π · A/m) | | | | | |
| | | | | | Scattered | Electric |
| | | | | Scattered | material | property |
| | | Residual | | material | magnetisation/ | Volume |
| | Magnetization | magnetization | Coercive force | magnetization | main body | resistance |
| No. | (Am²/kg) | (Am²/kg) | (1000/4π · A/m) | (Am²/kg) | magnetization | (Ω cm) |
| Example 1 | 91.2 | 1 | <10 | 89.2 | 0.98 | 2.5 × 10² |
| Example 2 | 91.2 | 1 | <10 | 88.1 | 0.97 | 6.5 × 10² |
| Example 3 | 90.8 | 1 | <10 | 88.3 | 0.97 | 1.5 × 10² |
| Example 4 | 78.7 | 1 | <10 | 75.0 | 0.95 | 4.8 × 10² |
| Example 5 | 90.1 | 4 | 20 | 86.1 | 0.96 | 7.2 × 10² |
| Example 6 | 94.2 | 2 | <10 | 92.5 | 0.98 | 1.1 × 10² |
| Example 7 | 85.6 | 1 | <10 | 83.6 | 0.98 | 4.2 × 10⁴ |
| Example 8 | 86.2 | 1 | <10 | 85.4 | 0.99 | 3.5 × 10² |
| Example 9 | 84.3 | 3 | 15 | 81.0 | 0.96 | 8.8 × 10⁴ |
| Example 10 | 79.3 | 3 | 20 | 75.1 | 0.95 | 1.1 × 10² |
| Comparative | 88.6 | 2 | 10 | 50.5 | 0.57 | 4.5 × 10³ |
| Example 1 | | | | | | |
| Comparative | 88.6 | 8 | 40 | 85.9 | 0.97 | 5.5 × 10¹ |
| Example 2 | | | | | | |
| Comparative | 32.0 | 2 | 15 | 30.1 | 0.94 | 7.7 × 10² |
| Example 3 | | | | | | |

| | | Surface coating | | | | |
|---|---|---|---|---|---|---|
| | | Coating resin | | Catalyst | | |
| | | | Amount | | Amount (in | Curing |
| | Carrier core material to be | | (in terms of | | terms of solid | condition |
| | coated | Kind | solid content) | Kind | content) | Temperature |
| Example 11 | Carrier core material | Silicone | 150 g | Aluminum | 2.5 g | 250° C. |
| | obtained in Example 1 | resin | | catalyst | | |
| Example 12 | Carrier core material | Silicone | 150 g | Aluminum | 2.5 g | 250° C. |
| | obtained in Example 2 | resin | | catalyst | | |
| Example 13 | Carrier core material | Silicone | 150 g | Aluminum | 2.5 g | 250° C. |
| | obtained in Example 3 | resin | | catalyst | | |
| Example 14 | Carrier core material | Silicone | 150 g | Aluminum | 2.5 g | 250° C. |
| | obtained in Example 4 | resin | | catalyst | | |
| Example 15 | Carrier core material | Silicone | 150 g | Aluminum | 2.5 g | 250° C. |
| | obtained in Example 5 | resin | | catalyst | | |
| Example 16 | Carrier core material | Silicone | 150 g | Aluminum | 2.5 g | 250° C. |
| | obtained in Example 6 | resin | | catalyst | | |
| Example 17 | Carrier core material | Silicone | 150 g | Aluminum | 2.5 g | 250° C. |
| | obtained in Example 7 | resin | | catalyst | | |
| Example 18 | Carrier core material | Silicone | 150 g | Aluminum | 2.5 g | 250° C. |
| | obtained in Example 8 | resin | | catalyst | | |
| Example 19 | Carrier core material | Silicone | 150 g | Aluminum | 2.5 g | 250° C. |
| | obtained in Example 9 | resin | | catalyst | | |
| Example 20 | Carrier core material | Silicone | 150 g | Aluminum | 2.5 g | 250° C. |
| | obtained in Example 10 | resin | | catalyst | | |
| Example 21 | Carrier core material | Acryl- | 150 g | Aluminum | 2.5 g | 250° C. |
| | obtained in Example 1 | modified | | catalyst | | |
| | | silicone | | | | |
| | | resin | | | | |
| Example 22 | Carrier core material | Silicone | 150 g | Titanium | 2.5 g | 250° C. |
| | obtained in Example 1 | resin | | catalyst | | |
| Example 23 | Carrier core material | Silicone | 150 g | Quaternary | 2.5 g | 250° C. |
| | obtained in Example 1 | resin | | ammonium | | |
| | | | | salt | | |
| Comparative | Carrier core material | Silicone | 150 g | Aluminum | 2.5 g | 250° C. |
| Example 4 | obtained in Comparative | resin | | catalyst | | |
| | Example 1 | | | | | |
| Comparative | Carrier core material | Silicone | 150 g | Aluminum | 2.5 g | 250° C. |
| Example 5 | obtained in Comparative | resin | | catalyst | | |
| | Example 2 | | | | | |
| Comparative | Carrier core material | Silicone | 150 g | Aluminum | 2.5 g | 250° C. |
| Example 6 | obtained in Comparative | resin | | catalyst | | |
| | Example 3 | | | | | |

| | Evaluation result of obtained carrier | |
|---|---|---|
| Surface coating | | Charge quantity by |
| Curing condition | Electric property | stirring time (μC/g) |

| | Time | Volume resistance Ω · cm | 1 min | 5 min | 15 min | 30 min |
|---|---|---|---|---|---|---|
| Example 11 | 2 hr | 2.1 × 10¹⁰ | 27.1 | 31.1 | 30.6 | 29.9 |
| Example 12 | 2 hr | 2.9 × 10⁹ | 28.4 | 32.2 | 32.1 | 31.7 |
| Example 13 | 2 hr | 1.8 × 10¹² | 22.3 | 28.9 | 27.7 | 25.5 |
| Example 14 | 2 hr | 8.9 × 10¹¹ | 29.2 | 33.8 | 32.5 | 31.7 |
| Example 15 | 2 hr | 1.8 × 10¹⁰ | 26.5 | 31.9 | 31.3 | 30.5 |
| Example 16 | 2 hr | 8.0 × 10⁹ | 25.2 | 30.4 | 29.8 | 29.4 |
| Example 17 | 2 hr | 4.6 × 10¹¹ | 25.9 | 30.3 | 29.1 | 28.2 |
| Example 18 | 2 hr | 7.3 × 10⁹ | 26.1 | 30.7 | 29.5 | 28.8 |
| Example 19 | 2 hr | 6.6 × 10¹⁰ | 26.9 | 32.0 | 31.7 | 31.0 |
| Example 20 | 2 hr | 9.2 × 10¹¹ | 27.1 | 33.8 | 33.4 | 32.8 |
| Example 21 | 2 hr | 1.9 × 10¹¹ | 37.1 | 42.1 | 40.5 | 39.3 |
| Example 22 | 2 hr | 6.9 × 10¹⁰ | 24.2 | 30.1 | 29.5 | 28.9 |
| Example 23 | 2 hr | 8.9 × 10¹⁰ | 24..8 | 31.1 | 30.6 | 28.5 |
| Comparative | 2 hr | 7.0 × 10¹⁰ | 14.9 | 34.3 | 28.6 | 19.7 |
| Example 4 | | | | | | |
| Comparative | 2 hr | 9.7 × 10⁷ | 12.2 | 29.2 | 21.9 | 13.8 |
| Example 5 | | | | | | |
| Comparative | 2 hr | 1.2 × 10¹³ | 7.2 | 16.8 | 25.5 | 34.3 |
| Example 6 | | | | | | |

As clarified from the results in Table 1, in Examples 1 to 10, the ratios of the scattered material magnetizations σ_{scattered material} and the main body magnetizations σ _{main body} (σ_{scatteredmaterial}/σ_{mainbody}) were larger than 0.95, and the scattered materials were confirmed to only scatter by the centrifugal force with the nearly same compositions as the carrier core material main bodies. By contrast, in Comparative Examples 1 and 3, the ratios of the scattered material magnetizations σ_{scattered material} and the main body magnetizations σ_{main body} (σ_{scattered material}/σ_{main body}) are below 0.95, and the carrier scattering is found to be that accompanying not only the centrifugal force but also the decrease in magnetization caused by inhomogeneous compositions. In Comparative Example 3, the measurement of the carrier core material by X-ray diffractometry detected a very weak peak of MnFe₂O₄ in addition to a strong peak of Fe₂O₃, and did not detect a peak of Fe₃O₄. This revealed that the main component in Comparative Example 3 was not a manganese ferrite, but Fe₂O₃. In Examples 1 to 10, in spite of that on every surface, clear unevenness was present, the true densities and the apparent densities were nearly equal to those of a ferrite carrier core material having little unevenness. Comparative Example 2 had a high residual magnetization and coercive force. Further, Comparative Examples 1 to 3 were inferior in fluidity.

As clarified from the results in Table 2, Examples 11 to 23 exhibited not only fast rising of the charge quantity, but also stable results having little variation in charge quantity during the evaluation. By contrast, Comparative Examples 4 to 6exhibited not only slow rising of charge quantity, but also resulted inferior in stability, and especially Comparative Example 5 had a low charge quantity. Comparative Example 6 had a high volume resistance.

The ferrite carrier core material for electrophotography according to the present invention has a homogeneous composition, a certain surface property, a favorable fluidity, a high magnetization and a low resistance. The electrophotographic developer using the ferrite carrier core material exhibits fast rising of charge quantity and a charging property stable with time, and can fully respond to the high-speed and full-color in developing machines. Besides, the production method according to the present invention allows the stable production having excellent productivity of the ferrite carrier for electrophotography.

1. A ferrite carrier core material for electrophotography having a surface divided into 2 to 50 regions per 10 μm square by grooves or streaks, the ferrite carrier core material comprising a manganese ferrite as a main component.

2. The ferrite carrier core material for electrophotography according to claim 1, wherein the ferrite carrier core material has a crystallite size of 130 to 400 Å, and a molar ratio of Fe to Mn (Fe/Mn) of 4 to 16.

3. The ferrite carrier core material for electrophotography according to claim 1 , wherein a part of Fe and Mn of the manganese ferrite composition is substituted with at least one element selected from the group consisting of Mg, Ca, Sr and Ti, and the sum of the contents thereof is 4 mol % or less.

4. The ferrite carrier core material for electrophotography according to claim 1, wherein the ferrite carrier core material has a magnetization of 60 to 95 Am²/kg in a magnetic field of 3K·1,000/4π·A/m.

5. The ferrite carrier core material for electrophotography according to claim 1, wherein the ferrite carrier core material has a volume resistance of 1×10² to 1×10⁶ Ω cm.

6. The ferrite carrier core material for electrophotography according to claim 1, wherein the ferrite carrier core material has a true density of 4.5 to 5.5 g/cm³.

7. The ferrite carrier core material for electrophotography according to claim 1, wherein the ferrite carrier core material has an average particle size of 15 to 120 μm.

8. A ferrite carrier for electrophotography obtaining by coating a surface of the ferrite carrier core material for electrophotography according to claim 1 with a resin.

9. The ferrite carrier for electrophotography according to claim 8, wherein the resin is a silicone resin or a modified silicone resin.

10. The ferrite carrier for electrophotography according to claim 9, wherein the resin contains a quaternary ammonium salt catalyst, an aluminum catalyst, or a titanium catalyst.

11. A method for producing a ferrite carrier core material for electrophotography, the method comprising grinding composite oxide having as main components Fe and Mn at a molar ratio (Fe/Mn) of 4 to 16, mixing the ground particles, granulating the mixture, sintering the granules, crushing the sintered product and classifying the crushed particles, wherein the sintering is performed at an oxygen concentration of 5 vol % or less.

12. The method for producing a ferrite carrier core material for electrophotography according to claim 11, wherein the composite oxide is particles produced by a wet synthesis.

13. The method for producing a ferrite carrier core material for electrophotography according to claim 11, wherein the composite oxide particles have an average particle size of 1 μm or less.

14. A method for producing a ferrite carrier for electrophotography, the method comprising coating a surface of a carrier core material obtained by the production method according to claim 11, with a resin.

15. An electrophotographic developer comprising the ferrite carrier according to claim 8 and a toner.
